(19) United States
(12) Patent Application Publication
(10) Pub. No.: US 2005/0251833 A1
(43) Pub. Date: Nov. 10, 2005

(54) Multiple function overhead entertainment system for use in a vehicle

(75) Inventor: George C. Schedivy, Aquebogue, NY (US)

Correspondence Address: F. CHAU & ASSOCIATES, LLC, 130 WOODBURY ROAD, WOODBURY, NY, 11797, US

(73) Assignee: Audiovox Corporation

(21) Appl. No.: 10/855,164

(22) Filed: May 27, 2004

Related U.S. Application Data
(63) Continuation-in-part of application No. 10/842,100, filed on May 10, 2004.

(51) Int. Cl. H04N 7/173; H04N 7/18

(52) U.S. Cl. 725/77; 725/74

(57) ABSTRACT

An overhead entertainment system for a vehicle comprises a a main body portion, a first media source and a second media source included in the main body portion, and at least one transmitter for wirelessly transmitting at least one of audio data and video data from at least one of the first and second media sources to at least one display.

### CROSS-REFERENCE TO RELATED APPLICATION

This application is a Continuation-In-Part of U.S. application Ser. No. 10/842,100, filed on May 10, 2004, the disclosure of which is incorporated herein in its entirety by reference.

### BACKGROUND OF THE INVENTION

1. Technical Field

The present disclosure relates to a multiple function overhead entertainment system for use in a vehicle, and more particularly to an overhead entertainment system capable of operating with a variety of media sources and different means for audio and video output.

2. Discussion of the Related Art

Overhead entertainment consoles mounted in vehicles provide video and audio entertainment to passengers therein. Some known designs of overhead consoles include a screen for displaying video and a media source, such as a video cassette player (VCP) or a digital video disc (DVD) player.

Known overhead consoles are limited with respect to the number and type of media sources that can be operated with the overhead console. Further, known overhead consoles are limited with respect to the number and type of audio and video delivery mechanisms that can be used with the overhead console.

Accordingly, a need exists for an overhead console that can operate with multiple media sources and is capable of outputting audio and video through a variety of output means.

### SUMMARY OF THE INVENTION

An overhead entertainment system for a vehicle, in accordance with an embodiment of the present invention, comprises a main body portion, a first display and a second display attached to the main body portion, a first media source and a second media source included in the main body portion, and a transmitter for wirelessly transmitting at least one of audio data and video data from at least one of the first and second media sources to at least a third display.

The transmitter may be positioned in at least one of the first display and the second display. The transmitter may transmit the audio and video data from one of the first and second media sources on more than one frequency. The transmitter may simultaneously transmit the audio and video data from the first and second media sources on at least two respective frequencies. The transmitter may simultaneously transmit formatted audio and video data from the first and second media sources. The transmitter may be one of an infrared transmitter and a radio frequency transmitter.

The overhead entertainment system may further comprise a source selector for selecting one of the first and second media sources from which the video and audio data is to be wirelessly transmitted. The first and second media sources may include any combination of two of the following: a DVD player, a CD-ROM player, a video game player, a videocassette player, a digital video recorder, an MP3 player, a card reader, a radio tuner and a TV tuner. The first and second media sources may play the same or different types of media. A third media source may be connectable to the main body portion. The overhead entertainment system may further comprise a TV tuner included in the main body portion.

The overhead entertainment system may further comprise another transmitter for wirelessly transmitting at least one of the audio data and the video data from at least one of the first and second media sources to at least a fourth display. The transmitter and the other transmitter may be respectively positioned in the first display and the second display, and may simultaneously transmit the video and audio data from the first and second media sources, respectively, to the third and fourth displays, respectively. The third display may be positioned remote from the main body portion.

The overhead entertainment system may be connectable to a modulator for modulating audio data received from one of the first and second media sources. The overhead entertainment system may further comprise a source selector for selecting one of the first and second media sources from which the audio data is received by the modulator.

An overhead entertainment system for a vehicle, in accordance with another embodiment of the present invention, comprises a main body portion, a first media source and a second media source included in the main body portion, and at least one transmitter positioned in the main body portion for wirelessly transmitting at least one of audio data and video data from at least one of the first and second media sources to at least one display.

The overhead entertainment system may comprise a band selector for selecting a frequency on which audio data received from one of the first and second media sources is to be modulated. The overhead entertainment system may further comprising a physical connection to at least one other display for transmitting at least one of the audio data and the video data from at least one of the first and second media sources to the at least one other display, and at least one source selector for selecting one of the first and second media sources from which the video and audio data is to be transmitted to the at least one other display.

### BRIEF DESCRIPTION OF THE DRAWINGS

Preferred embodiments of the invention can be understood in more detail from the following descriptions taken in conjunction with the accompanying drawings in which:

FIG. 1 shows a perspective view of an overhead entertainment unit, according to an embodiment of the present invention;

FIG. 2A is a block diagram illustrating an overhead entertainment unit including a modulator and a transmitter, according to an embodiment of the present invention;

FIG. 2B is a block diagram illustrating an overhead entertainment unit including two modulators, according to an embodiment of the present invention;

FIG. 3A is a block diagram illustrating a wired connection between the overhead entertainment unit of FIG. 2B and a vehicle sound system, according to an embodiment of the present invention;

FIG. 3B is a block diagram illustrating a wireless connection between the overhead entertainment unit of FIG. 2B and a vehicle sound system and wireless headphones, according to an embodiment of the present invention;

FIG. 3C is a block diagram illustrating switching between the wired and wireless connections shown in FIGS. 3A and 3B, according to an embodiment of the present invention;

FIG. 4A is a block diagram illustrating an overhead entertainment unit including a video transmitter, according to an embodiment of the present invention;

FIG. 4B shows a perspective view of an overhead entertainment unit, according to an embodiment of the present invention;

FIG. 5A shows a front view of an overhead entertainment unit, according to an embodiment of the present invention;

FIG. 5B shows a rear view of an overhead entertainment unit, according to an embodiment of the present invention;

FIG. 5C shows a bottom view of an overhead entertainment unit, according to an embodiment of the present invention;

FIG. 5D shows right and left side views of an overhead entertainment unit, according to an embodiment of the present invention;

FIG. 5E is a block diagram of wireless transmitters in displays of an overhead entertainment unit, according to an embodiment of the present invention;

FIG. 6A shows a front view of an overhead entertainment unit, according to an embodiment of the present invention;

FIG. 6B shows a rear view of an overhead entertainment unit, according to an embodiment of the present invention;

FIG. 6C shows a bottom view of an overhead entertainment unit, according to an embodiment of the present invention;

FIG. 6D is a block diagram of wireless transmitters included in an overhead entertainment unit, according to an embodiment of the present invention; and

FIG. 7 is a block diagram illustrating an overhead entertainment unit or a display including a wireless transmitter, according to an embodiment of the present invention.

### DETAILED DESCRIPTION OF THE PREFERRED EMBODIMENTS

Preferred embodiments of the present invention will be described below in more detail with reference to the accompanying drawings. This invention may, however, be embodied in different forms and should not be construed as limited to the embodiments set forth herein. Rather, these embodiments are provided so that this disclosure will be thorough and complete, and will fully convey the scope of the invention to those skilled in the art.

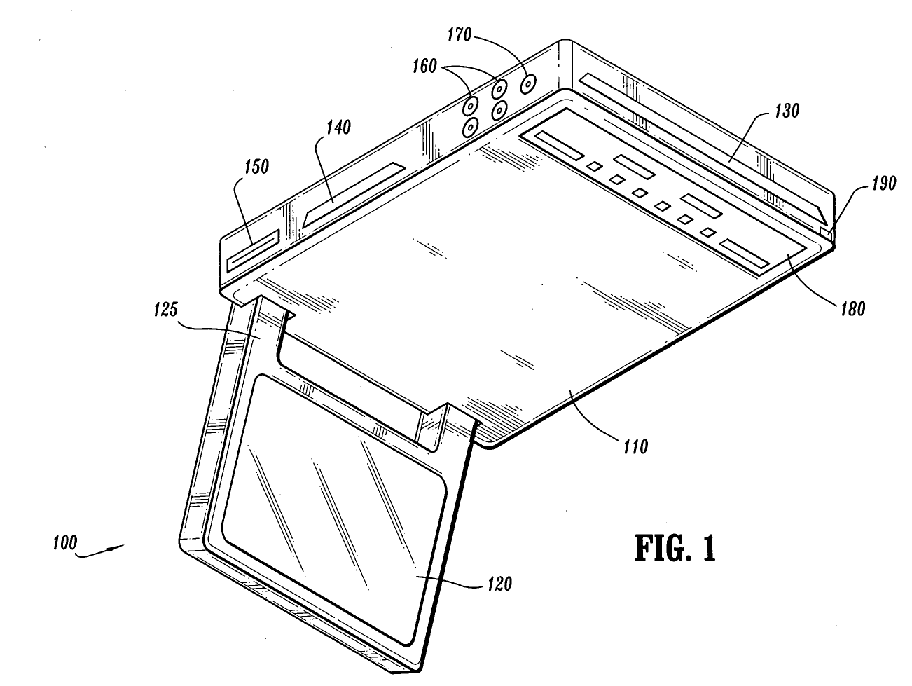

Referring to FIG. 1, an overhead entertainment unit 100 includes a display 120, which is preferably a liquid crystal display (LCD). Alternatively, the display 120 can be a cathode ray tube (CRT), gas plasma or organic electro-luminescent display (OELD) device. The display 120 is preferably supported from the entertainment unit 100 by a hinged mechanism 125 and swings to different viewing angles or folds flat against a body portion 110 of the entertainment unit 100 when not in use.

The entertainment unit 100 includes slots 130 and 140 of different sizes for receiving DVDs, compact discs (CDs), video CDs (VCDs), flash cards, secure digital (SD) cards, smart media (SM) cards and memory stick (MS) cards. Accordingly, the entertainment unit 100 includes media players, such as card readers and DVD and CD players, capable of reading various types of media storage mediums. The entertainment unit 100 can transfer audio data to an audio output, such as headphones or a vehicle sound system and transfer video data to a video output, such as the display 120. As an alternative to using slots, media storage mediums can also be inserted into the entertainment unit 100 using a clamshell type design, whereby a door of the entertainment unit 100 is opened to allow insertion of a media storage medium therein. In addition, a drawer type design may also be implemented whereby a holder for a media storage medium slides out of the entertainment unit 100 (like a drawer) to permit insertion of a media storage device in the holder.

The entertainment unit 100 also includes ports for connecting to external media devices, such as a universal serial bus (USB) port 150 and input/output ports 160. The ports 150 and 160 are used to connect devices, such as an MPEG player, a card reader, a DVD player, a CD-ROM player, a video game player, a videocassette player, and a digital video recorder. For example, audio input ports include XLR and RCA jacks and video input ports include S-video connections, RCA connections, F-connections, and component video. The entertainment unit 100 includes a headphone port 170 for sending audio to headphones. A power port may be included among the input/output ports 160 for connecting to a vehicle power supply through an adapter, such as cigarette lighter adapter. The entertainment unit 100 preferably receives power through a vehicle's wiring harness.

The slots 130 and 140 and the ports 150, 160 and 170 may be positioned in any appropriate location on the entertainment unit 100 and are not restricted to the locations shown in FIG. 1. Similarly, the number of slots and ports may be more or less than that shown in FIG. 1.

The entertainment unit 100 includes a control panel 180 with a variety of control buttons for controlling, for example, power, mode (e.g., DVD, AUX), screen characteristics, and functions of a media source, such as stop, pause, previous, play and next. The control buttons enable a user to control display characteristics and which programs from which sources are displayed. Additional control buttons can include volume control and channel selection. A channel selection button is used to select a frequency, such as 88.1 MHz, for broadcast of audio if audio is being broadcast wirelessly to headphones or to the vehicle's sound system.

The entertainment unit 100 also includes an infra-red (IR) sensor 190 for receiving signals for control of the entertainment unit 100 from a remote control device.

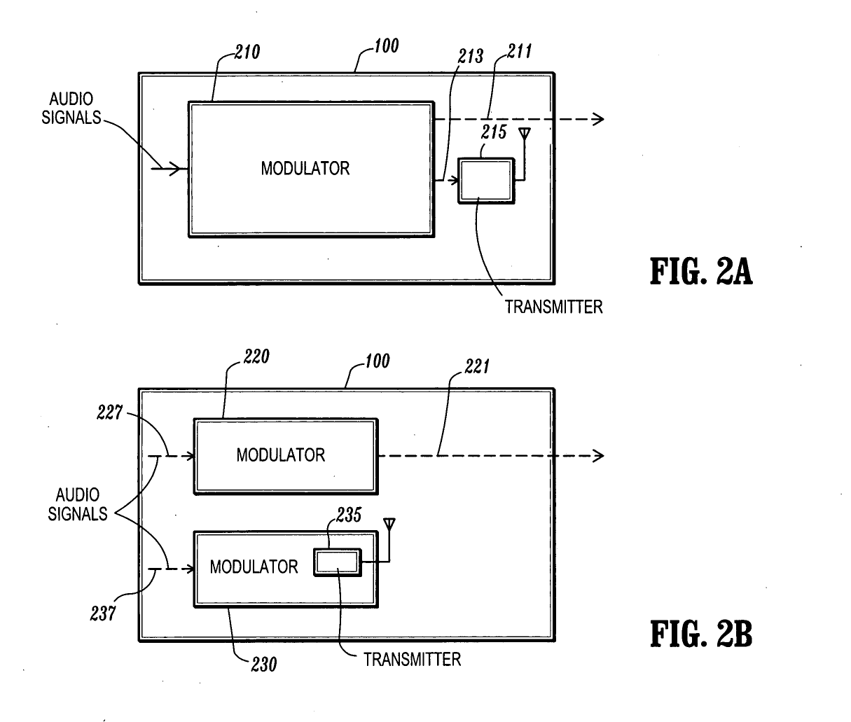

Referring to FIGS. 2A-2B, the entertainment unit 100 either includes a frequency modulator 210 connectable to a transmitter 215 or two frequency modulators 220 and 230. The modulators 210, 220 and 230 modulate audio signals received from a media source in or connected to the entertainment unit 100 for transmission on a selected frequency to a vehicle sound system, such as a radio, or to wireless headphones. Once a modulated signal is received by the radio or wireless headphones, which are tuned to the chosen frequency, the audio signals are then demodulated and are respectively output to speakers in the vehicle or wireless headphones.

Upon installation of the entertainment unit 100 shown in FIG. 2A into a vehicle, a user may opt to connect the modulator 210 directly to a vehicle sound system via a wired connection as shown by arrow 211. The wired connection permits the modulated audio signal to travel via a wire or wires to the vehicle sound system. Alternatively, as shown by arrow 213, the user may opt to connect the modulator 210 to the transmitter 215 instead of wiring the modulator 210 to the vehicle sound system. The transmitter 215 wirelessly transmits a modulated signal to a vehicle antenna and, in turn to the vehicle sound system connected to the vehicle antenna. The transmitter 215 is also capable of transmitting a modulated signal to a receiver in wireless headphones.

The connection to the transmitter 215 may be determined at installation or may be controlled by a selector switch on the control panel 180. If controlled by a selector switch, a user may use the transmitter 215 with wireless headphones regardless of whether the modulator 210 is wired to the vehicle sound system. For example, if the vehicle sound system is turned off and the connection to the transmitter 215 is switched on, the transmitter 215 may be used to transmit modulated audio signals to a receiver in wireless headphones or some other audio output device not connected to the vehicle. Also, in an alternative embodiment, the direct connection between the modulator 210 and the vehicle system may be opened and closed by a selector switch positioned on the control panel 180. Therefore, the inclusion of switches for connecting and disconnecting the modulator 210 to and from the vehicle sound system and the transmitter 215 gives a user the option to choose between wireless and wired transmission after installation of the overhead entertainment unit 100.

The wireless transmission frequency can be selected using a channel selection button on the control panel 180. The frequency can be in the FM band, ranging from about 88 MHz to about 108 MHz or in a digital audio broadcast (DAB) band, including frequencies in and beyond the FM band, ranging from about 88 MHz to about 225 MHz. Frequency may be tunable to a number of frequencies in the ranges in increments of 0.1 MHZ.

Upon installation of the entertainment unit 100 shown in FIG. 2B into a vehicle, a user may opt to connect the modulator 220 directly to a vehicle sound system via a wired connection as shown by arrow 221 and, as shown by arrow 227, to create a connection to the modulator 220 for receipt of audio signals to be modulated from a media source in or connected to the entertainment unit 100. Accordingly, modulated audio signals travel from the modulator 220 via a wire or wires to the vehicle sound system.

Alternatively, as shown by arrow 237, the user may opt to create a connection to the modulator 230 for receipt of the audio signals to be modulated. Therefore, instead of sending modulated signals via a wired connection to the vehicle sound system, a transmitter 235 included in the modulator 230 wirelessly transmits modulated signals to a vehicle antenna and, in turn to the vehicle sound system connected to the antenna. Like the transmitter 215, the transmitter 235 is also capable of transmitting a modulated signal to a receiver in wireless headphones. In another configuration, in order to achieve wireless transmission of the modulated signals, the connections shown by arrows 227 and 237 are in place, while the connection shown by arrow 221 is eliminated. The presence of the connection shown by arrow 221 can be determined at installation of the entertainment system or controlled by a switch positioned on the control panel 180.

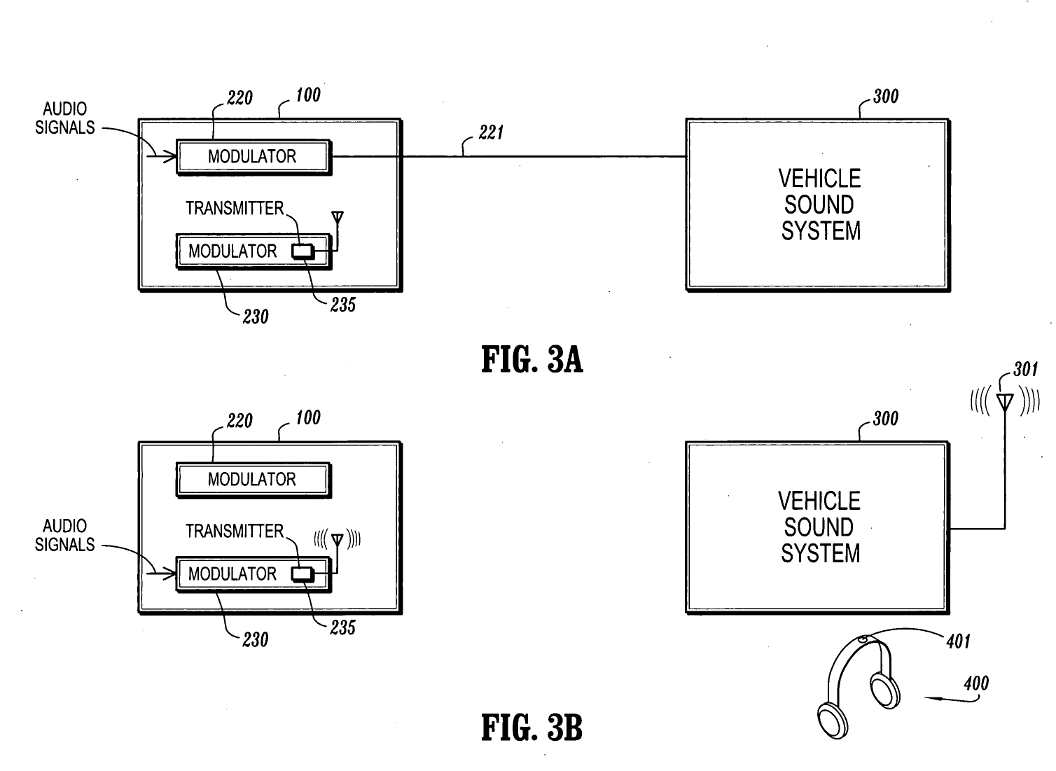

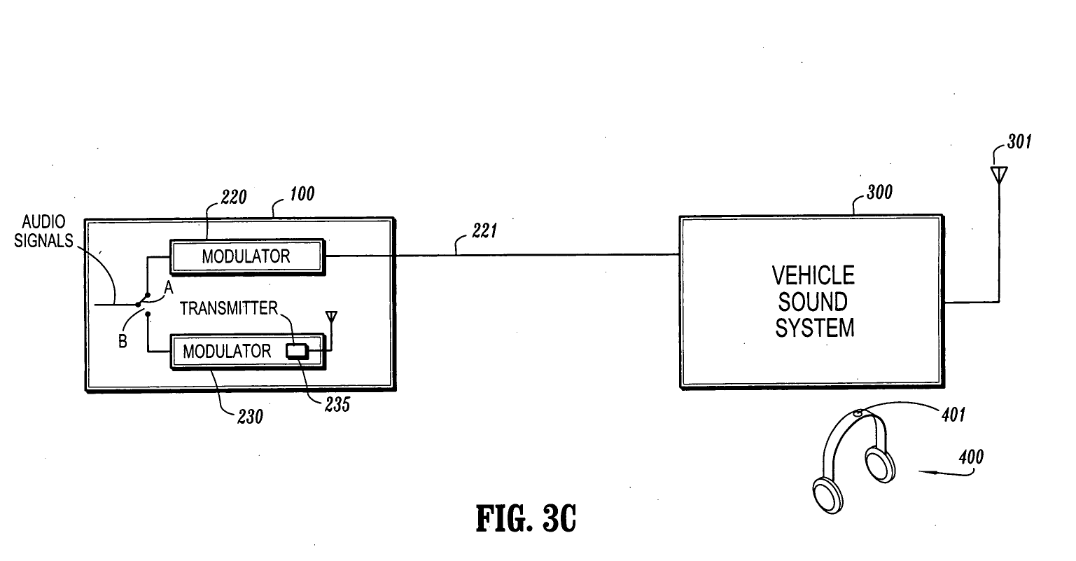

As shown in FIG. 3A, audio signals to be modulated are input to the modulator 220 and a wired connection 221 between the modulator 220 and the vehicle sound system 300 transmits the modulated audio signals to the vehicle sound system 300. As shown in FIG. 3B, audio signals to be modulated are input to the modulator 230 and a transmitter 235 wirelessly transmits the modulated audio signals to an antenna 301 of the vehicle sound system 300 or to a receiver 401 in wireless headphones 400. As shown in FIG. 3B, there is no connection between the modulator 220 and the vehicle sound system 300.

Referring to FIG. 3C, the modulator 220 is wired to the vehicle sound system 300 like the embodiment shown in FIG. 3A. However, in the embodiment shown in FIG. 3C, a user can control whether the audio signals to be modulated are sent to modulator 220 or modulator 230. As shown in FIG. 3C, a switch, which can be positioned on control panel 180, is set to position A to enable input of the audio signals to modulator 220 and position B to enable input of the audio signals to modulator 230. Accordingly, at any time, a user can select between wired and wireless transmission of modulated audio signals to the vehicle sound system 300. Further, by switching to position B, a user can enable wireless transmission of modulated audio signals to wireless headphones 400.

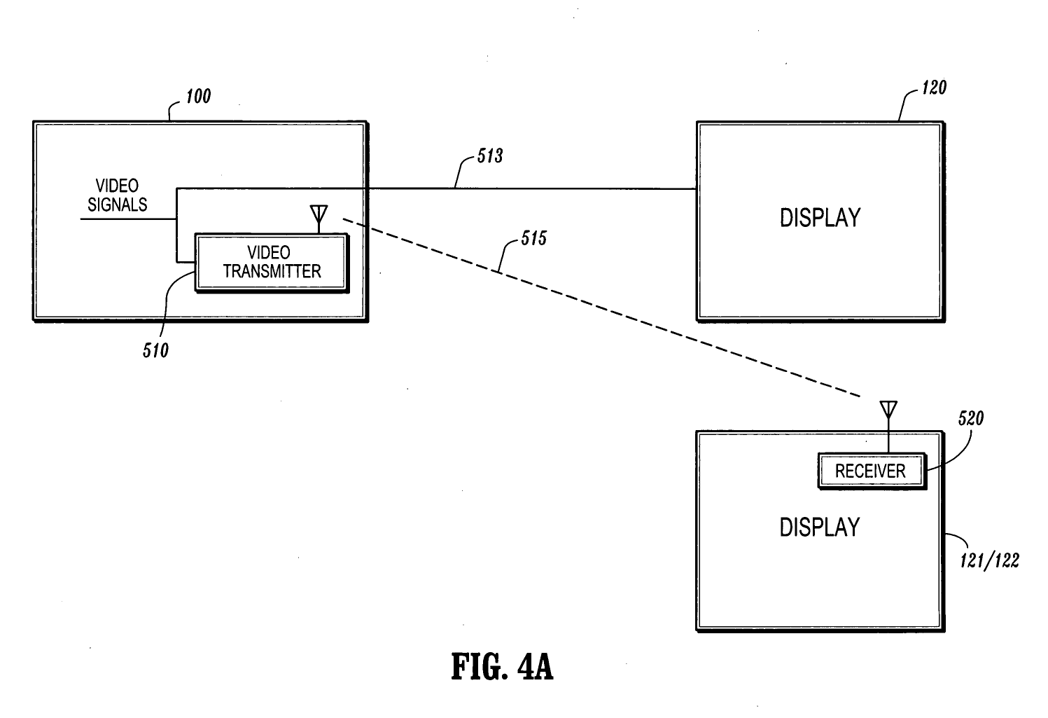

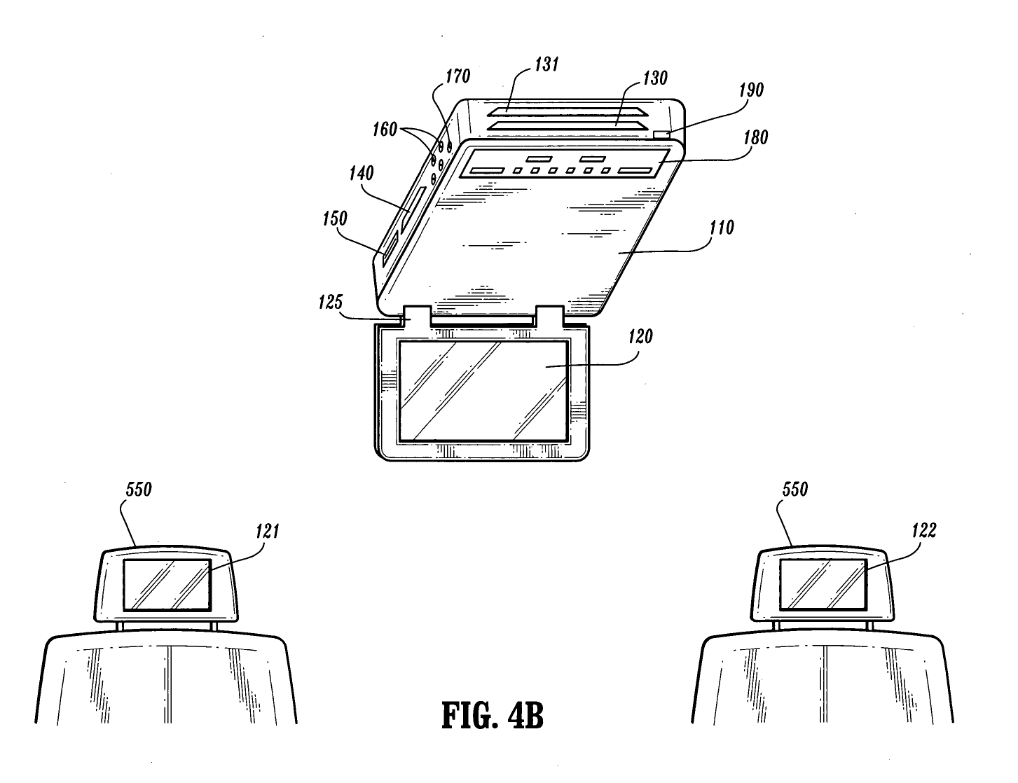

Referring to FIGS. 4A-4B, video signals from a media source connected to or included in the entertainment unit 100, such as an MPEG player, a card reader, a DVD player, a VCD player, a video game player, a videocassette player, and a digital video recorder, are provided to a display 120 via a wired connection path 513 and to displays 121 and 122 via a wireless transmission path 515. As shown in FIG. 4A, the video signals are input to a video transmitter unit 510, including processing components for formatting the video signals for wireless transmission (e.g., wireless radio frequency (RF) transmission) to a receiver 520 located in each display 121 and 122. Formatting may include compression of the video data using, for example, MPEG, MPEG-2 and MPEG-4 procedures. The compressed video data is formatted for RF wireless transmission on an appropriate frequency. The displays 121 and 122 include components, such as demodulators and decoders to reformat the transmitted video data for display. Such reformatting may include decompression of compressed video data. As shown in FIG. 4B, the displays 121 and 122 may be located on the back of a vehicle seat headrest 550. The displays 121 and 122 may be positioned anywhere in the vehicle, such as in the hands of a passenger, on a center console or on the vehicle ceiling. Displays positioned remotely from the entertainment 100 preferably receive video data via wireless transmission. Alternatively, like the display 120, the displays 121 and 122 can be connected to the entertainment unit 100 via a wired connection. Further, any number of displays may be used and the display 120 may be omitted from entertainment unit 100, with video signals still being transmitted to displays positioned remote from the entertainment unit 100.

It is to be understood that in addition to being transmitted via both wired and wireless paths 513 and 515, the path of the video signals may be predetermined at installation so that only the wired or wireless path is used. Further, with a switch located on the control panel 180, a user may select either a wired or wireless connection for transmission of video data.

It is to be understood that more than one media source may be played at one time so that multiple passengers in a vehicle may simultaneously view separate programs on different displays and/or listen to different programs through different audio mechanisms (e.g., through separate headphone sets). Similarly, as shown in FIG. 4B, multiple slots 130, 131 and multiple media players for receiving and playing the same type of media storage medium (e.g., two DVDs) may also be provided such that different programs from the more than one of the same type of media storage medium may be simultaneously played.

The entertainment unit 100 is preferably capable of outputting different programs from multiple media sources, such that displays 120, 121 and 122, wireless headphones 400, and/or vehicle sound systems 300 tuned to an appropriate channel or configured to select a specific program (e.g., through a selection made by an on-screen menu), can receive desired programs through either wired or wireless paths. The entertainment unit 100 may include multiple wired connections and/or multiple wireless transmitters for transmitting audio and video signals corresponding to different programs. For example, audio and video data may be wirelessly transmitted from multiple transmitters via RF or infrared (IR) transmission, where different frequencies from each respective transmitter correspond to different programs. Also, video and audio data from multiple media sources may be wirelessly transmitted from a transmitter in a broadcast stream, and a user may select a program for viewing on a display through, for example, a menu displayed on a screen of the display. In another embodiment, by utilizing a selector button located on the control panel 180, a user may select a desired media source from which video and/or audio data is to be transmitted and received.

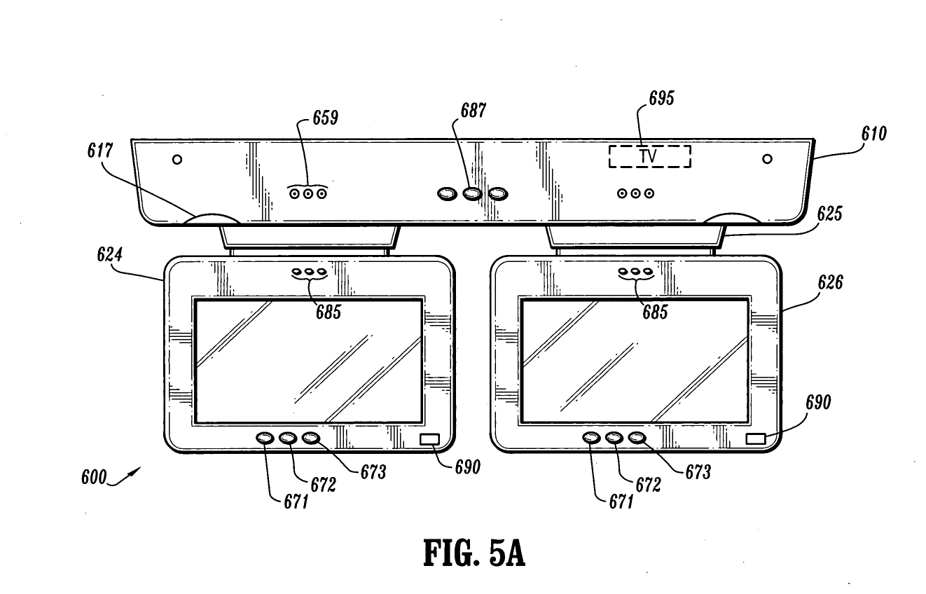

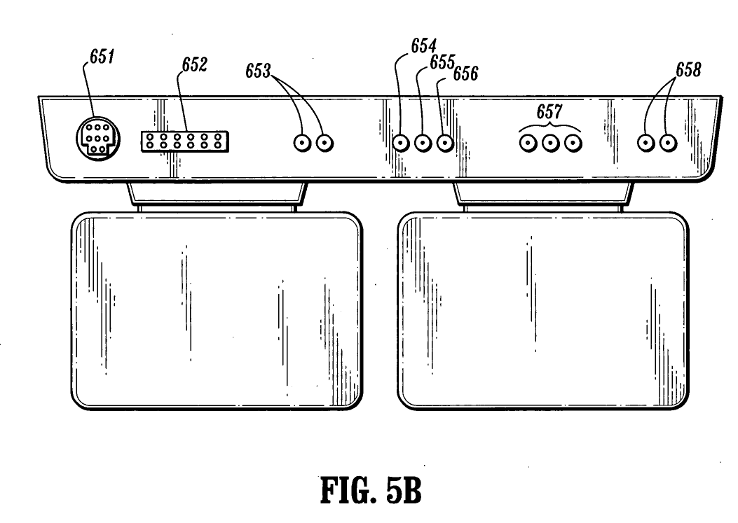

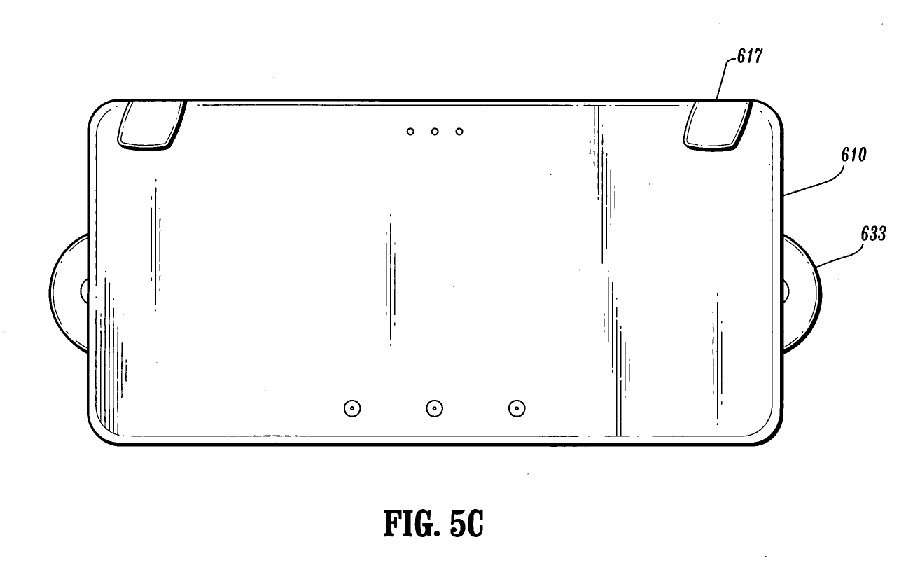

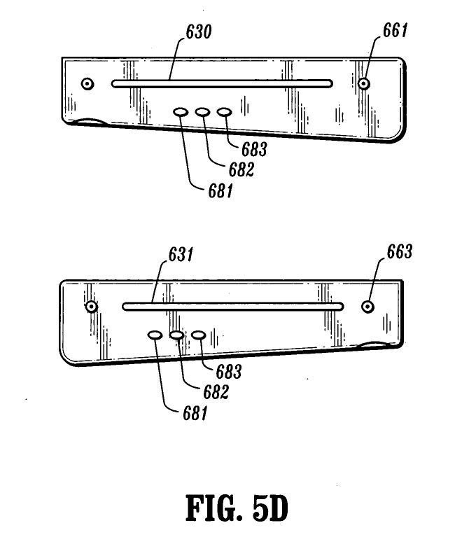

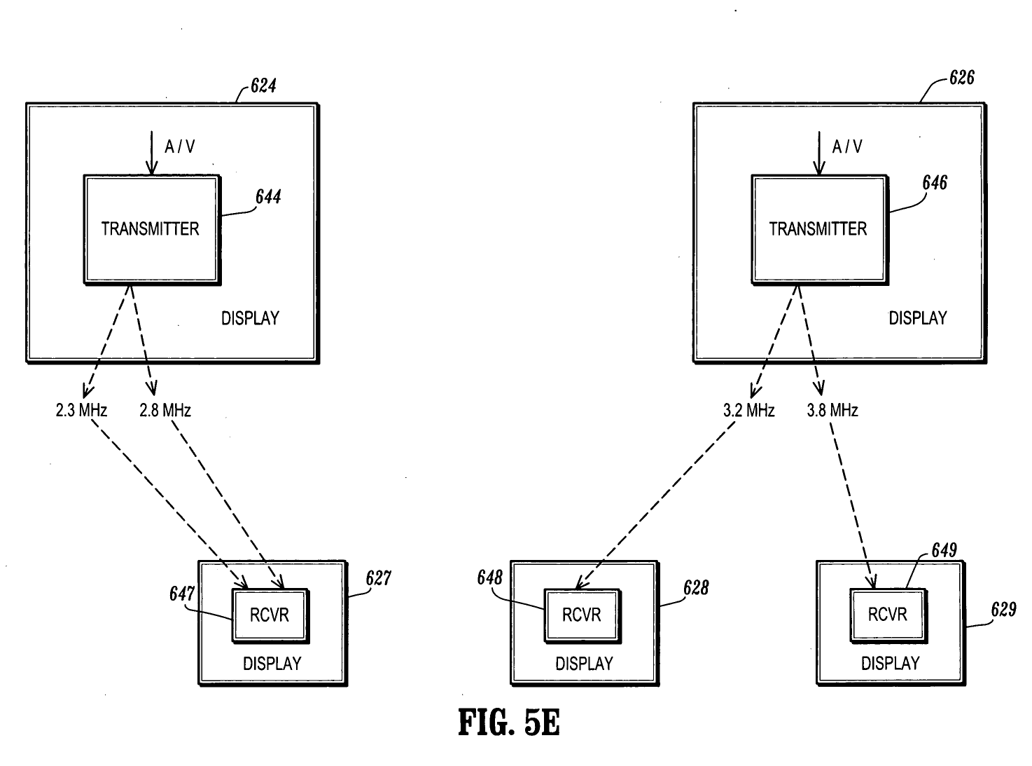

Referring to FIGS. 5A-5D, an overhead entertainment unit 600 includes a main body portion 610 to which two displays 624 and 626 are coupled. The displays 624, 626 are preferably liquid crystal displays (LCDs). Alternatively, the displays 624, 626 can be a cathode ray tube (CRT), gas plasma or organic electro-luminescent display, (OELD) devices. The displays 624, 626 are preferably supported from the main body portion 610 by a hinged mechanism 625 and swing to different viewing angles or fold flat against the body portion 610 when not in use. Overhead dome lights 617 are also provided on the entertainment unit 600. The displays 624 and 626 each include an infra-red (IR) sensor 690 for receiving signals for control of the displays 624 and 626, and of the entertainment unit 600 from a remote control device.

As shown in FIG. 5D, the entertainment unit 600 includes slots 630 and 631 on right and left sides of the main body portion 610 for receiving media storage mediums 633, such as DVDs, compact discs (CDs), video CDs (VCDs), CD-ROMs and MP3 discs. Accordingly, the entertainment unit 600 includes media players, such as DVD and CD players, capable of reading the media storage mediums 633. As an alternative to using slots, media storage mediums can also be inserted into the entertainment unit 600 using a clamshell type design, whereby a door positioned on the entertainment unit 600 is opened to allow insertion of a media storage medium therein. In addition, a drawer type design may also be implemented whereby a holder for a media storage medium slides out of the entertainment unit 600 (like a drawer) to permit insertion of a media storage medium in the holder. The entertainment unit 600 also includes a TV tuner 695 for receiving and playing TV programs. A TV system is preferably in accordance with National Television System Committee (NTSC) standards.

As shown in FIGS. 5A, 5B and 5D, the entertainment unit 600 includes ports for inputting and outputting audio and video to and from the entertainment unit 600. For example, the entertainment unit 600 includes an 8 pin Din jack 651, a 12 pin connector 652, an F connector pigtail 653, video and audio out ports 654-656, RCA jacks 657-659, and headphone ports 661 and 663. The ports and connectors provide for AV input and output to and from the entertainment unit 600, including, for example AUX and TV antenna inputs. AV output via, for example, an RCA jack pigtail may be used for FM modulator connectivity so that audio for a selected program can be transmitted to the vehicle sound system. Other types of ports, such as USB ports, XLR jacks, S-connections and power ports may also be provided on the entertainment unit 600. The slots and ports may be positioned in any appropriate location on the entertainment unit 600 and are not restricted to the locations shown in the drawings. Similarly, the number of slots and ports may be more or less than that shown in the drawings.

The entertainment unit 600 includes a variety of controls for controlling, for example, power, program sources (e.g., DVD, AUX), screen characteristics, and functions of a media source, such as stop, play and eject. Control buttons 671-673 positioned on the displays 624 and 626 control, for example, power on/off, screen mode and program source, respectively. The program source button 673 enables a user to control whether a program from specific source is displayed on the display 624 and/or 626. For example, by depressing the source button 673, a user may select a program for display from one of the DVD players built in to the entertainment unit 600, the TV tuner 695, or an AUX input.

As shown in FIG. 5D, buttons for controlling DVD functions 681-683 are positioned on the sides of the body portion 610. Buttons 681-683, control, for example, play, stop and eject functions of a DVD player. As shown in FIG. 5A, the entertainment unit 600 includes an FM modulator source select button 687 for selecting the source of a program output to an FM modulator. Additional control buttons (not shown) can include volume control and channel selection for the TV tuner.

As shown in FIG. 5E, each monitor 624 and 626 respectively includes a transmitter 644 and 646. The transmitters 644 and 646 are preferably IR transmitters, transmitting IR signals including audio and video data to additional displays 627-629 positioned remote from the entertainment unit 600, for example, on a vehicle seat, or hand held. The displays 627-629 include receivers 647-649 for receiving the IR signals. The IR signals are transmitted via an IR lens or lenses 685 positioned on the face of each display 624 and 626.

Each transmitter 644 and 646 is capable of transmitting audio and video data on different frequencies to avoid interference between respective transmitters transmitting different programs. In one embodiment, a transmitter 644 transmits a program from a selected source on two frequencies 2.3 MHz and 2.8 MHz, wherein the AV data of the program is divided into left and right components, corresponding to the 2.3 and 2.8 MHz, respectively. The source is selected using button 673. A receiver 647 in display 627 receives the left and right components.

Although not shown in FIG. 5E, left and right components of a program from another selected source may be transmitted from transmitter 646 to another display (e.g., display 628 and/or 629) as left and right components corresponding to 3.2 and 3.8 MHz, respectively, so as to avoid interference with the program being simultaneously transmitted from transmitter 644.

In another embodiment, the transmitter 646 may simultaneously transmit more than one program from more than one selected source. Such transmission is performed on different frequencies (e.g., 3.2 and 3.8 MHz) corresponding to each program. Each program is sent to a respective receiver 648 and 649 located in a display 628 and 629. It is to be understood that more or less displays than shown in the drawings may be used in conjunction with the transmitters 644 and 646.

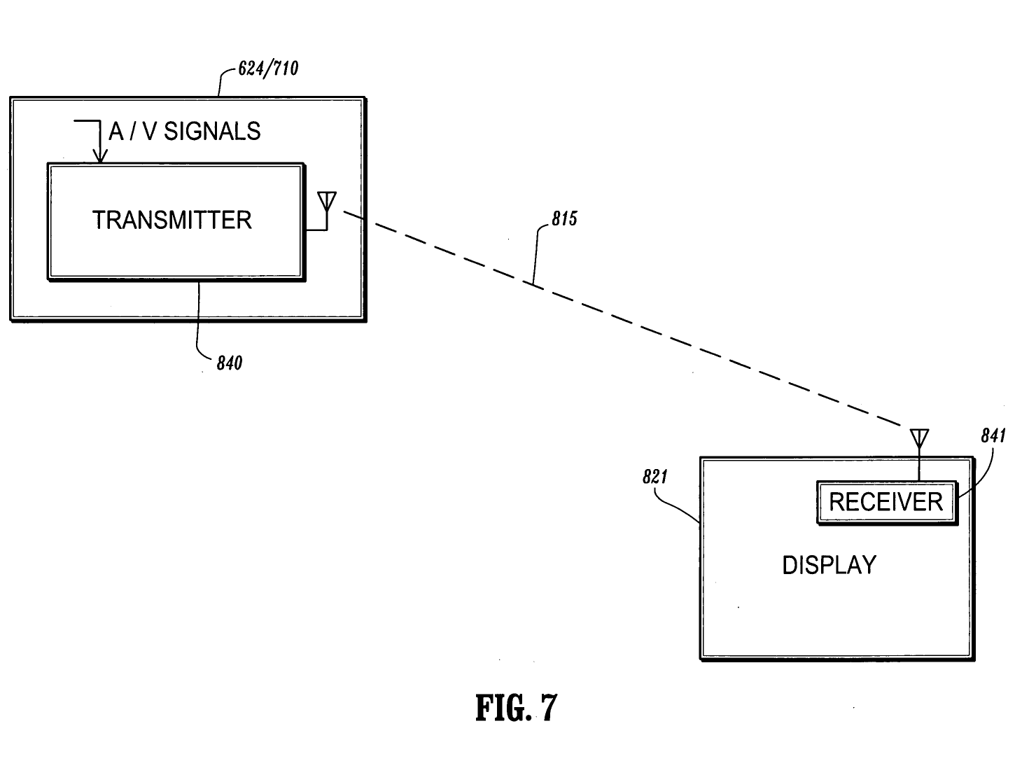

Referring to FIG. 7, audio and video data from a selected media source provided to a display coupled to the main body 610 (e.g., display 624), is inputted to a transmitter unit 840 positioned in the display 624. The transmitter unit 840 includes processing components for formatting the audio and video signals for wireless transmission (e.g., wireless radio frequency (RF) transmission) via path 815 to a receiver 841 located in a remotely positioned display 821. Formatting may include compression of the audio and video data using, for example, MPEG, MPEG-2 and MPEG-4 procedures. The compressed audio and video data is formatted for RF wireless transmission on an appropriate frequency. The display 821 includes components, such as a demodulator and decoder to reformat the transmitted audio and video data for broadcast on the display 821. Such reformatting may include decompression of compressed video data. Like the displays 627-629, the display 821 may be located on a vehicle seat or positioned anywhere in the vehicle, such as in the hands of a passenger, on a center console or on the vehicle ceiling.

The display 624 also may simultaneously transmit, via transmitter 840, different programs from multiple media sources to display 821. The video and audio data from multiple media sources can be wirelessly transmitted in a broadcast stream, and a user may select a program for viewing on the display 821 through, for example, a menu displayed on a screen of the display 821. Any number of displays like the display 821 including a receiver 841 may be used in conjunction with transmitter 840.

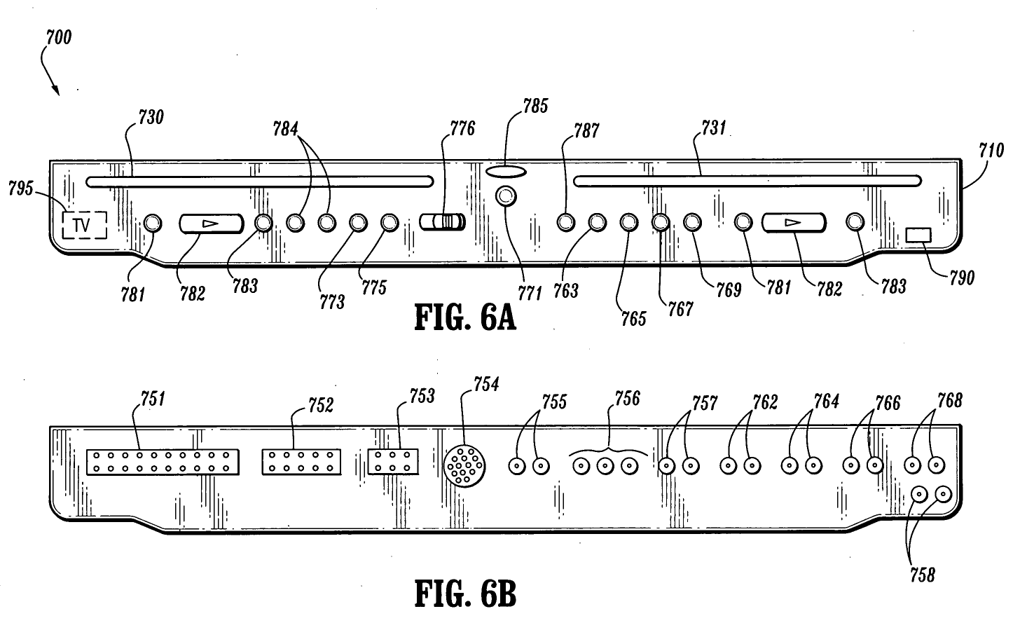

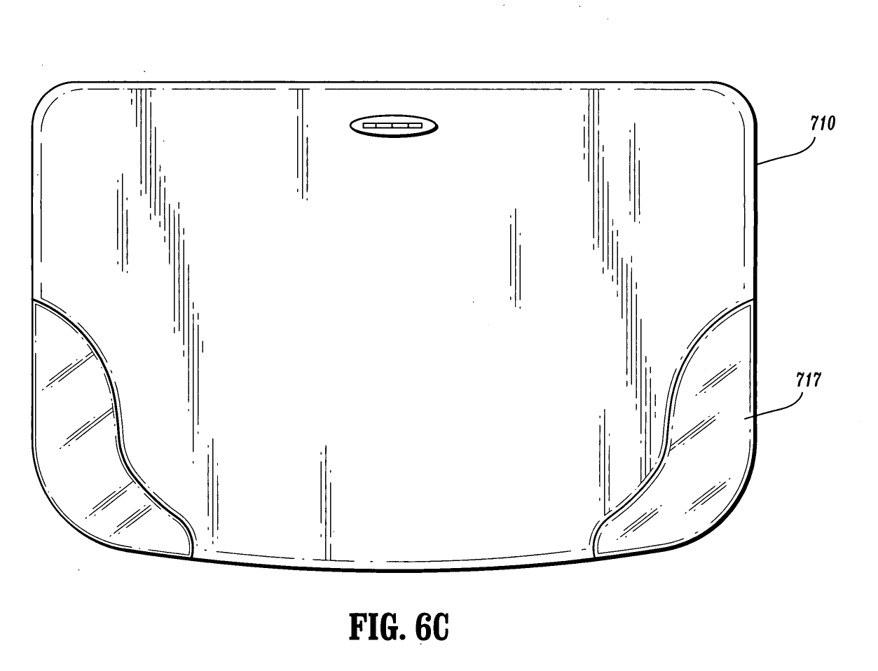

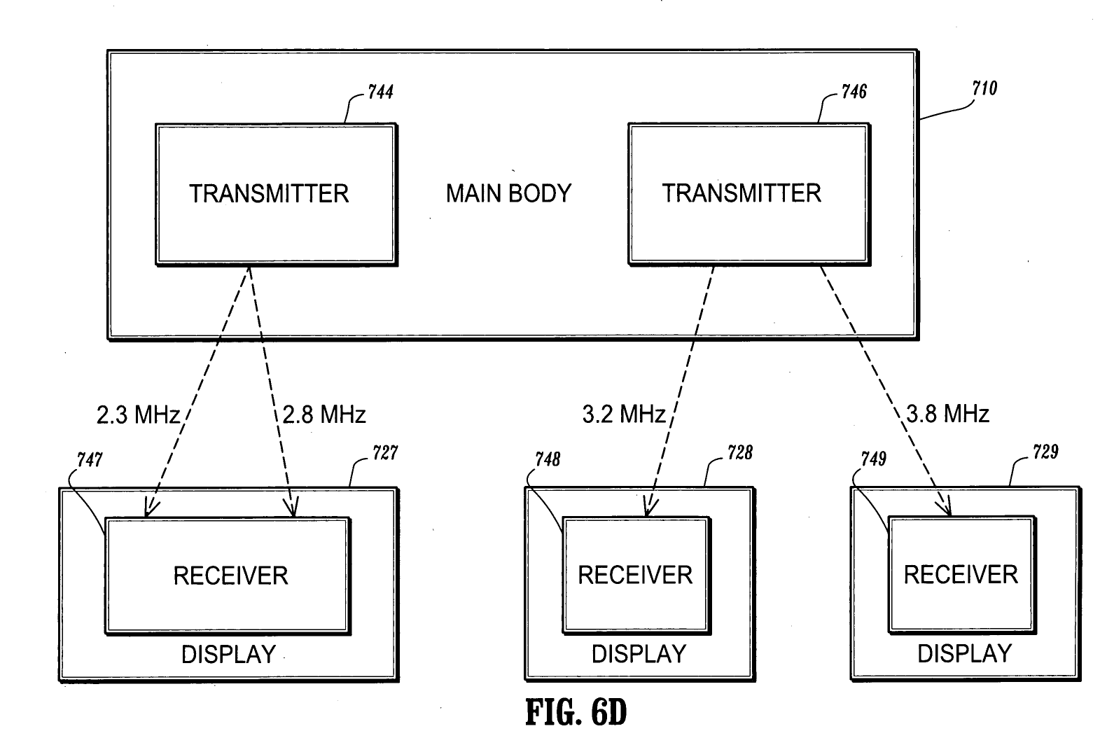

Referring to FIGS. 6A-6C, an overhead entertainment unit 700 includes a main body portion 710, overhead dome lights 717, and an IR sensor 790 for receiving signals for control of the entertainment unit 700 from a remote control device.

As shown in FIG. 6A, the entertainment unit 700 includes slots 730 and 731 on the front face of the main body portion 710 for receiving media storage mediums, such as DVDs, compact discs (CDs), video CDs (VCDs), CD-ROMs and MP3 discs. Accordingly, the entertainment unit 700 includes media players, such as DVD and CD players, capable of reading the media storage mediums. As an alternative to using slots, media storage mediums can also be inserted into the entertainment unit 700 using a clamshell or drawer type design. The entertainment unit 700 also includes a TV tuner 795 for receiving and playing TV programs. A TV system is preferably in accordance with National Television System Committee (NTSC) standards.

As shown in FIG. 6B, the entertainment unit 700 includes ports for inputting and outputting audio and video to and from the entertainment unit 700. For example, the entertainment unit 700 includes an 18 pin connector 751, an 8 pin connector 752, a 6 pin connector 753, a 14 pin connector 754, an F connector pigtail 755, and RCA jacks 756-758, 762, 764, 766 and 768. The ports and connectors provide for AV input and output to and from the entertainment unit 700, including, for example satellite radio audio, TV antenna and dome light power inputs. AV output via, for example, 14 pin connector may be used for FM modulator connectivity so that audio for a selected program can be transmitted to the vehicle sound system. Other types of ports, such as USB ports, XLR jacks, S-connections and power ports may also be provided on the entertainment unit 700. The slots and ports may be positioned in any appropriate location on the entertainment unit 700 and are not restricted to the locations shown in the drawings. Similarly, the number of slots and ports may be more or less than that shown in the drawings.

AV output via RCA jacks pigtail (e.g., jacks 762, 764, 766 and 768) can be used to provide a wired connection from each program source to a display. For example, each AV output 762, 764, 766 and 768 is linked to a respective source select key 763, 765, 767, and 769. Therefore, each AV output 762, 764, 766 and 768 can select the source from which AV signals are output to a display. For example, by depressing the source control buttons 763, 763, 767 and 769, a user may select programs for display from one of the DVD players built in to the entertainment unit 700, the TV tuner 795, an auxiliary input or satellite radio.

The entertainment unit 700 also includes buttons for controlling DVD functions 781-783 such as stop, play and eject and channel up and down buttons 784 for controlling TV channels. As shown in FIG. 5A, the entertainment unit 700 also includes a power on/off button 771, an FM modulator band select key 776 for selecting a frequency for FM modulation and an FM modulator source select button 787 for selecting the source of a program to be output to an FM modulator.

Referring to FIG. 6D, the main body portion 710 includes transmitters 744 and 746. The transmitters 744 and 746 are preferably IR transmitters, transmitting IR signals including audio and video data to displays 727-729 positioned remote from the entertainment unit 700, for example, on a vehicle seat, or hand held. The displays 727-729 include receivers 747-749 for receiving the IR signals. The IR signals are transmitted via an IR lens 785 positioned on the front face the main body portion 710.

Like the transmitters 644 and 646, each transmitter 744 and 746 is capable of transmitting audio and video data on different frequencies to avoid interference between respective transmitters transmitting different programs. In one embodiment, a transmitter 744 transmits a program from a selected source on two frequencies 2.3 MHz and 2.8 MHz, wherein the AV data of the program is divided into left and right components, corresponding to the 2.3 and 2.8 MHz, respectively. The source is selected using button 773. A receiver 747 in display 727 receives the left and right components.

Although not shown in FIG. 6D, left and right components of a program from another selected source may be transmitted from transmitter 746 to another display (e.g., display 728 and/or 729) as left and right components corresponding to 3.2 and 3.8 MHz, respectively, so as to avoid interference with the program being simultaneously transmitted from transmitter 744. The other source corresponding to transmitter 746 is selected using selector button 775.

In another embodiment, the transmitter 746 may simultaneously transmit more than one program from more than one selected source. Such transmission is performed on different frequencies (e.g., 3.2 and 3.8 MHz) corresponding to each program. Each program is sent to a respective receiver 748 and 749 located in a display 728 and 729. It is to be understood that more or less displays than shown in the drawings may be used in conjunction with the transmitters 744 and 746.

Referring to FIG. 7, audio and video data from a selected media source built-in or coupled to the entertainment unit 700 is inputted to a transmitter unit 840 positioned in the main body portion 710. The transmitter unit 840 includes processing components for formatting the audio and video signals for wireless transmission (e.g., wireless radio frequency (RF) transmission) via path 815 to a receiver 841 located in a remotely positioned display 821. Formatting may include compression of the audio and video data using, for example, MPEG, MPEG-2 and MPEG-4 procedures. The compressed audio and video data is formatted for RF wireless transmission on an appropriate frequency. The display 821 includes components, such as a demodulator and decoder to reformat the transmitted audio and video data for broadcast on the display 821. Such reformatting may include decompression of compressed video data. Like the displays 727-729, the display 821 may be located on a vehicle seat or positioned anywhere in the vehicle, such as in the hands of a passenger, on a center console or on the vehicle ceiling.

The entertainment unit 700 may simultaneously transmit, via transmitter 840, different programs from multiple media sources to display 821. The video and audio data from multiple media sources can be wirelessly transmitted in a broadcast stream, and a user may select a program for viewing on the display 821 through, for example, a menu displayed on a screen of the display 821. Any number of displays like the display 821 including a receiver 841 may be used in conjunction with transmitter 840. The entertainment unit 700 may include more than one transmitter 840 in the main body portion 710.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

1. An overhead entertainment system for a vehicle, comprising:
a main body portion;
a first display and a second display attached to the main body portion;
a first media source and a second media source included in the main body portion; and
a transmitter for wirelessly transmitting at least one of audio data and video data from at least one of the first and second media sources to at least a third display.

2. The overhead entertainment system as recited in claim 1, wherein the transmitter is positioned in at least one of the first display and the second display.

3. The overhead entertainment system as recited in claim 1, wherein the transmitter transmits the audio and video data from one of the first and second media sources on more than one frequency.

4. The overhead entertainment system as recited in claim 1, wherein the transmitter simultaneously transmits the audio and video data from the first and second media sources on at least two respective frequencies.

5. The overhead entertainment system as recited in claim 1, wherein the transmitter simultaneously transmits formatted audio and video data from the first and second media sources.

6. The overhead entertainment system as recited in claim 1, wherein the transmitter is one of an infrared transmitter and a radio frequency transmitter.

7. The overhead entertainment system as recited in claim 1, further comprising a source selector for selecting one of the first and second media sources from which the video and audio data is to be wirelessly transmitted.

8. The overhead entertainment system as recited in claim 1, wherein the first and second media sources include any combination of two of the following: a DVD player, a CD-ROM player, a video game player, a videocassette player, a digital video recorder, an MP3 player, a card reader, a radio tuner and a TV tuner.

9. The overhead entertainment system as recited in claim 1, wherein the first and second media sources play the same type of media.

10. The overhead entertainment system as recited in claim 1, wherein the first and second media sources play different media.

11. The overhead entertainment system as recited in claim 1, wherein a third media source is connectable to the main body portion.

12. The overhead entertainment system as recited in claim 1, further comprising a TV tuner included in the main body portion.

13. The overhead entertainment system as recited in claim 1, further comprising another transmitter for wirelessly transmitting at least one of the audio data and the video data from at least one of the first and second media sources to at least a fourth display.

14. The overhead entertainment system as recited in claim 13, wherein said transmitter and said another transmitter are respectively positioned in the first display and the second display.

15. The overhead entertainment system as recited in claim 13, wherein said transmitter and said another transmitter simultaneously transmit the video and audio data from the first and second media sources, respectively, to the third and fourth displays, respectively.

16. The overhead entertainment system as recited in claim 1, wherein the third display is positioned remote from the main body portion.

17. The overhead entertainment system as recited in claim 1, wherein the overhead entertainment system is connectable to a modulator for modulating audio data received from one of the first and second media sources.

18. The overhead entertainment system as recited in claim 17, further comprising a source selector for selecting one of the first and second media sources from which the audio data is received by the modulator.

19. An overhead entertainment system for a vehicle, comprising:
a main body portion;
a first media source and a second media source included in the main body portion; and
at least one transmitter positioned in the main body portion for wirelessly transmitting at least one of audio data and video data from at least one of the first and second media sources to at least one display.

20. The overhead entertainment system as recited in claim 19, wherein the at least one transmitter transmits the audio and video data from one of the first and second media sources on more than one frequency.

21. The overhead entertainment system as recited in claim 19, wherein the at least one transmitter simultaneously transmits the audio and video data from the first and second media sources on at least two respective frequencies.

22. The overhead entertainment system as recited in claim 19, wherein the at least one transmitter simultaneously transmits formatted audio and video data from the first and second media sources.

23. The overhead entertainment system as recited in claim 19, wherein the at least one transmitter is one of an infrared transmitter and a radio frequency transmitter.

24. The overhead entertainment system as recited in claim 19, further comprising a source selector for selecting one of the first and second media sources from which the video and audio data is to be wirelessly transmitted.

25. The overhead entertainment system as recited in claim 19, wherein the first and second media sources include any combination of two of the following:
a DVD player, a CD-ROM player, a video game player, a videocassette player, a digital video recorder, an MP3 player, a card reader, a radio tuner and a TV tuner.

26. The overhead entertainment system as recited in claim 19, wherein the first and second media sources play the same type of media.

27. The overhead entertainment system as recited in claim 19, wherein the first and second media sources play different media.

28. The overhead entertainment system as recited in claim 19, wherein a third media source is connectable to the main body portion.

29. The overhead entertainment system as recited in claim 19, further comprising a TV tuner included in the main body portion.

30. The overhead entertainment system as recited in claim 19, further comprising at least one other transmitter positioned in the main body portion for wirelessly transmitting at least one of the audio data and the video data from at least one of the first and second media sources to at least one other display.

31. The overhead entertainment system as recited in claim 30, wherein the at least one transmitter and the at least one other transmitter simultaneously transmit the video and audio data from the first and second media sources, respectively, to the at least one and at least one other displays, respectively.

32. The overhead entertainment system as recited in claim 19, wherein the at least one display is positioned remote from the main body portion.

33. The overhead entertainment system as recited in claim 19, wherein the overhead entertainment system is connectable to a modulator for modulating audio data received from one of the first and second media sources.

34. The overhead entertainment system as recited in claim 33, further comprising a source selector for selecting one of the first and second media sources from which the audio data is received by the modulator.

35. The overhead entertainment system as recited in claim 33, further comprising a band selector for selecting a frequency on which the audio data is to be modulated.

36. The overhead entertainment system as recited in claim 19, further comprising a physical connection to at least one other display for transmitting at least one of the audio data and the video data from at least one of the first and second media sources to the at least one other display.

37. The overhead entertainment system as recited in claim 36, further comprising at least one source selector for selecting one of the first and second media sources from which the video and audio data is to be transmitted to the at least one other display.

38. An overhead entertainment system for a vehicle, comprising:
a main body portion;
a first display and a second display attached to the main body portion; and
a first media source and a second media source included in the main body portion.

39. The overhead entertainment system as recited in claim 38, wherein the first and second media sources include any combination of two of the following: a DVD player, a CD-ROM player, a video game player, a videocassette player, a digital video recorder, an MP3 player, a card reader, a radio tuner and a TV tuner.

40. The overhead entertainment system as recited in claim 38, wherein the first and second media sources play the same type of media.

41. The overhead entertainment system as recited in claim 38, wherein the first and second media sources play different media.

42. The overhead entertainment system as recited in claim 38, wherein a third media source is connectable to the main body portion.

43. The overhead entertainment system as recited in claim 42, wherein the third media source connects to the main body portion via at least one input port located on the main body portion.

44. The overhead entertainment system as recited in claim 38, further comprising a TV tuner included in the main body portion.

45. The overhead entertainment system as recited in claim 1, wherein the overhead entertainment system is connectable to a modulator for modulating audio data received from one of the first and second media sources.

46. The overhead entertainment system as recited in claim 44, further comprising a source selector for selecting one of the first and second media sources from which the audio data is received by the modulator.

47. The overhead entertainment system as recited in claim 38, wherein each of the first and second displays are operatively coupled to at least one of the first and second media sources for receiving video data for display from at least one of the first and second media sources.

48. The overhead entertainment system as recited in claim 38, wherein each of the first and second displays are operatively coupled to both the first and second media sources for receiving video data for display from the first and second media sources.

49. The overhead entertainment system as recited in claim 48, further comprising a selector for selecting one of the first and second media sources from which the video data is received.

50. The overhead entertainment system as recited in claim 48, further comprising a first selector corresponding to the first display and a second selector corresponding to the second display, wherein each of the first and second selectors select one of the first and second media sources from which the video data is received.
